(19) United States
(12) Patent Application Publication
(10) Pub. No.: US 2007/0194242 A1
(43) Pub. Date: Aug. 23, 2007

(54) Scintillation Layer For A Pet-Detector

(75) Inventors: Klaus Fiedler, Aachen (DE); Torsten Solf, Aachen (DE); Andreas Thon, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS NV, Eindhoven (NL)

(21) Appl. No.: 10/595,741

(22) PCT Filed: Nov. 16, 2004
(86) PCT No.: PCT/IB04/52447

§ 371 Date: Mar. 8, 2007

(30) Foreign Application Priority Data
Nov. 25, 2003 (EP) 03104352.4

(51) Int. Cl. G01T 1/20; G01T 1/24

(52) U.S. Cl. 250/370.11

(57) ABSTRACT

The invention relates to a scintillation layer (20) for a PET-detector. The scintillation layer (20) consists of a plurality of scintillation elements (21) that are joined together in a practically gapless way and that are oriented towards the centre of curvature (24). Depending on the form of the scintillation layer (20), the scintillation elements (21) may have for example the form of a truncated wedge or pyramid.

The invention relates to a scintillation layer for a PET-detector, a PET-detector with such a scintillation layer, and a procedure for the production of such a scintillation layer.

Scintillation layers are needed for PET-detectors in order to convert gamma-quanta into visible light. The visible light can then be detected by further sensors like for example photomultipliers. Scintillation layers often consist of a plurality of scintillation elements in the form of cuboids which are arranged side by side in the scintillation layer. Furthermore scintillation layers are often curved. Therefore, if cuboid-shaped scintillation elements are assembled with their axes oriented towards the centre of curvature of the scintillation layer, tapered gaps arise at their radially external side. From the U.S. Pat. No. 6,285,028 B1 a curved scintillation layer is known with cuboid-shaped scintillation elements disposed parallel to each other. By arranging the scintillation elements in different heights, a curved scintillation layer with a stepped outer surface and inner surface can be made. Gamma rays which come e.g. from the centre of curvature of the scintillation layer pass the scintillation elements depending on their direction of propagation under different angles. This can lead to position dependent artifacts during the conversion of the gamma rays in the scintillation layer.

Based on this situation it was an object of the present invention to provide means for an improved detection of gamma rays in a scintillation layer.

This task is solved by a scintillation layer according to claim 1, by a PET-detector according to claim 4, and by a procedure according to claim 6. Preferred embodiments are subject to the dependent claims.

The scintillation layer according to the invention is in particular suited for the use in a PET-detector. It comprises a curved internal surface and/or a curved outer surface. Preferably the internal surface and the outer surface are concentric, i.e. run parallel to each other and have the same centre of curvature. Furthermore the scintillation layer consists of a plurality of scintillation elements, the scintillation elements being joined together with minimal gaps between them and oriented (with their body axes and/or their side faces) towards the centre of curvature of the scintillation layer. If there are gaps greater than zero between the scintillation elements, they are typically filled by materials that are necessary for the optimal function of the scintillation layer. One important example for such a material are reflecting foils which reflect light back into a scintillation element in order to avoid cross talk.

Due to the dense, practically gapless (i.e. no gaps besides the spaces needed for reflecting foils or the like) coupling of the scintillation elements the average path length a gamma ray travels in the scintillation layer becomes maximal. Therefore the probability of detection for gamma-quanta and the light yield are maximal, too. Furthermore gamma rays coming from the centre of curvature run approximately parallel to the body axes of the scintillation elements at all positions of the scintillation layer and independently of their direction of propagation. Thus the gamma rays encounter homogeneous geometrical conditions everywhere in the scintillation layer so that no position dependent artifacts like those in a detector according to U.S. Pat. No. 6,285,028 B1 arise.

The scintillation layer may in particular be cylindrically with the scintillation elements having the form of a wedge or a frustum of a wedge, respectively.

Alternatively the scintillation layer can be curved in an ellipsoidal way. In particular it can be spherically curved, i.e. have the form of a calotte. In this case the scintillation elements have the form of a frustum of a pyramid.

The invention comprises also a PET-detector with a scintillation layer that is constituted in one of the ways described above. Therefore, reference is made to the preceding description for more information on the details, advantages and improvements of that PET-detector.

Finally the invention relates to a procedure for the production of a scintillation layer for a PET-detector. According to the procedure a plurality of scintillation elements are joined together with minimal gaps between them, the gaps being typically filled with an intermediate material like a reflecting foil. The scintillation elements are shaped in such a way that the resulting scintillation layer is curved and that the body axes of the scintillation elements are oriented towards the centre of curvature of the scintillation layer when the scintillation elements are at their place in the scintillation layer.

By the procedure a scintillation layer of the kind described above is produced. Therefore, reference is made to the corresponding description for more information on the details, advantages and improvements of the procedure.

According to a preferred embodiment of the procedure the scintillation elements are cut out of larger scintillation crystals. Thus it is particularly possible to produce scintillation elements with flat surfaces.

According to an alternative method the scintillation elements are produced from ceramic scintillation materials by press-forming. The press-forming allows to produce scintillation elements with curved outer surfaces if desired.

In the following the invention is described by way of example with the help of the accompanying drawings in which:

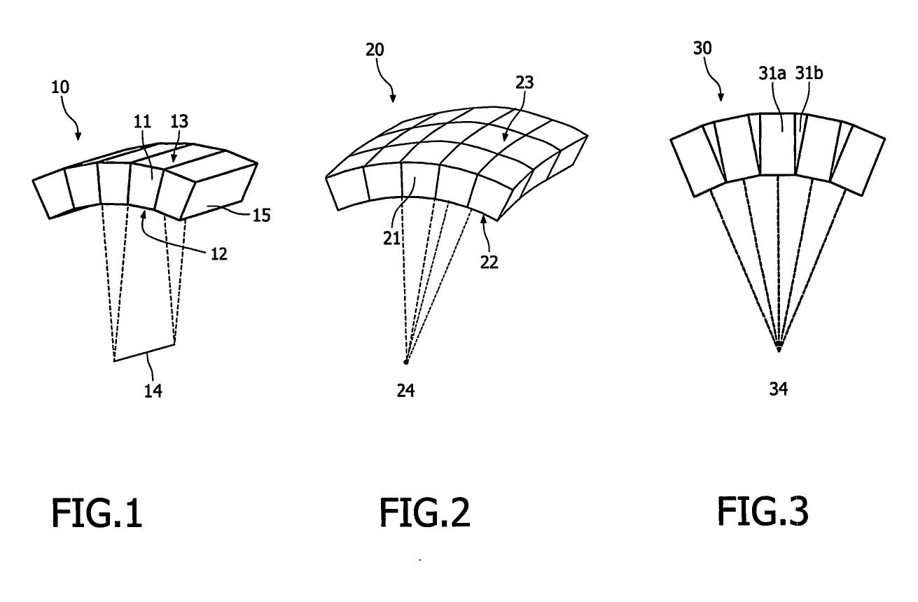

FIG. 1 is a perspective view of a part of a scintillation layer with wedge like scintillation elements;

FIG. 2 is a perspective view of a part of a scintillation layer with pyramid-shaped scintillation elements;

FIG. 3 is a sectional view of a curved scintillation layer with differently shaped scintillation elements.

In FIG. 1 only a small part of a scintillation layer 10 is represented. The scintillation layer 10 is used for the conversion of γ-quanta into photons of visible light, and it can particularly be employed in a PET-detector. In this case the area of the scintillation layer is typically (semi-)annular and measures about 20 cm×300 cm. Moreover, at least two such scintillation layers 10 are arranged opposite to each other in a PET-detector in order to allow detection of the coincidence of two γ-quanta from an annihilation process.

The scintillation layer 10 represented in FIG. 1 is bent cylindrically, the centre of curvature being an axis 14. The scintillation layer 10 is composed of a plurality of individual scintillation elements 11. In order to avoid or minimise gaps between the joined scintillation elements 11, they are shaped like frustum wedges (i.e. prisms with a trapezoidal cross section). Between two neighbouring scintillation elements 11 there is normally a reflecting foil (not shown) which fills any remaining gap. The (imaginary) tips of the corresponding whole wedges all lie on the curvature axis 14. Thus it is achieved that the scintillation elements 11 are oriented with their body axes and/or their side faces 15 towards the centre of curvature 14 of the scintillation layer 10. Since the gamma rays basically all come from an area near the centre of curvature 14 during the use of the scintillation layer 10 in a PET-detector, they hit the scintillation elements 11 parallel to their body axes. This rotational symmetry of the arrangement helps to avoid artifacts which may arise in systems like that of U.S. Pat. No. 6,285,028 B1. Furthermore the probability to detect a gamma quantum in the scintillation layer 10 and the light yield a gamma quantum produces are both maximized by the minimally spaced joining of the scintillation elements 11.

The scintillation elements 11 can for example be produced by cutting them from a larger scintillation crystal. Suitable scintillation materials are particularly GSO, LYSO and LaBr₃. Since cutting basically produces flat surfaces, the internal surface 12 as well as the outer surface 13 of the scintillation layer 10 are not bent smoothly but put together from individual flat faces.

FIG. 2 shows a part of another scintillation layer 20 which is spherically curved. In this case the centre of curvature is a (mid)point 24. The scintillation layer 20 again consists of a plurality of scintillation elements 21 of the same kind. In this case the scintillation elements 21 each have the form of a truncated pyramid (with rectangular and/or quadratic cross-sectional area). They are arranged in such a way that the (imaginary) tip of the pyramids reside in the centre of curvature 24. Again a maximal probability for detection of gamma rays and a high light yield as well as an isotropy with respect to the centre of curvature 24 are achieved by the practically gapless joining of the scintillation elements 21 and by their orientation towards the centre of curvature 24.

In FIG. 2 the internal surface 22 as well as the outer surface 23 of the scintillation layer 20 are spherically curved in a smooth way. In order to achieve this, the internal faces and outer faces of the individual scintillation elements 21 must be curved, too. Such scintillation elements 21 may be produced for example by press-forming of ceramic scintillation materials. A suitable scintillation material for this purpose is for example LuAG.

FIG. 3 shows a section through a part of a scintillation layer 30 which is curved in space spherically, cylindrically or otherwise. In this case the scintillation layer 30 is assembled from cuboid-shaped scintillation elements 31a which are oriented with their body axes towards the centre of curvature 34 of the scintillation layer 30. Moreover, the tapered gaps arising between the elements 31 a are filled with wedge-shaped scintillation elements 31b. These tapered scintillation elements 31b are oriented with their body axes towards the centre of curvature 34, too. They provide for a practically gapless scintillation layer 30 with maximum probability of detection of gamma-quanta and light yield.

1. A Scintillation layer for a PET-detector with a curved internal surface and/or a curved outer surface, comprising a plurality of scintillation elements that are joined together with minimal gaps and that are oriented towards the centre of curvature of the scintillation layer.

2. The scintillation layer according to claim 1, wherein it is cylindrically curved and that it comprises scintillation elements having the form of a truncated wedge.

3. The scintillation layer according to claim 1, wherein it is curved in an ellipsoidal way and that it comprises scintillation elements having the form of a truncated pyramid.

4. The scintillation layer according to claim 1, wherein gaps between neighbouring scintillation elements are filled with a reflecting material.

5. A PET-detector with a scintillation layer the scintillation layer having a curved internal surface and/or a curved outer surface and comprising a plurality of scintillation elements that are joined together with minimal gaps and that are oriented towards the centre of curvature of the scintillation layer.

6. The PET-detector according to claim 5, wherein the scintillation layer is designed according to claim 2.

7. A method for the production of a scintillation layer for a PET-detector comprising joining a plurality of scintillation elements with minimal gaps, the scintillation elements being shaped in such a way that the resulting scintillation layer is curved and orienting the scintillation elements towards the centre of curvature of the scintillation layer.

8. The method according to claim 7, wherein the resulting scintillation layer is designed according to claim 2.

9. The method according to claim 7, wherein the scintillation elements are cut from scintillation crystals.

10. The method according to claim 7, wherein the scintillation elements are produced by press-forming of ceramic scintillation materials.

11. An imaging detector comprising:
a plurality of scintillation elements that are joined together to form a substantially gapless scintillation layer with a substantially continuous curved detection surface; and
one or more photodection elements that sense light photons generated by the scintillation elements.

12. The imaging detector of claim 11, wherein the scintillation elements are comprised of GSO, LSO, LYSO, LuAG, LaBr₃ or a combination of any such materials.

13. The imaging detector of claim 11, wherein each scintillation element as a depth and a width that varies with the depth.

14. The imaging detector of claim 13, wherein the widths of each of the scintillation elements are substantially for any given scintillation element depth.

15. The imaging detector of claim 11, wherein the scintillation layer includes a substantially continuous curved outer surface.
